(19) United States
(12) Patent Application Publication
(10) Pub. No.: US 2010/0214993 A1
(43) Pub. Date: Aug. 26, 2010

(54) APPARATUS AND METHOD FOR RESOURCE ALLOCATION FOR SOUNDING CHANNEL

(75) Inventors: Andrei Malkov, Muurla (FI); Sergei Semenov, Salo (FI); Xin Qi, Beijing (CN)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/390,222

(22) Filed: Feb. 20, 2009

(51) Int. Cl. H04W 72/04

(52) U.S. Cl. 370/329

(57) ABSTRACT

In accordance with an example embodiment of the present invention, a method is disclosed that comprises receiving a resource reservation request for a sounding channel, the resource reservation request comprising a first transmission direction and a first set of logical resources; mapping the first set of logical resources to a first set of physical resources, at least in part based on the first transmission direction; and mapping the first set of physical resources to a second set of logical resources at least in part based on a second transmission direction.

### TECHNICAL FIELD

The present application relates generally to an apparatus and a method for resource allocation for uplink sounding channel.

### BACKGROUND

IEEE 802.16 defines an industry standard network technology also called Worldwide Interoperability for Microwave Access (WiMax). WiMax has adopted the channel sounding technique for communicating channel response information from a mobile station (MS) to a base station (BS). Sounding channel is time-frequency sub-carriers that are reserved for allocation of the sounding signals. Depending on the method of maintaining orthogonality between sounding signals, one time-frequency sub-carrier may be used by one or more mobile stations.

Allocation of the sounding channel may take place either prior to or after the allocation of the sounding signals. The former approach may allow for optimizing downlink signaling. A base station may broadcast parameters of the sounding channel to all coupled mobile stations and unicast parameters of the individual sounding signal only to those dedicated mobile stations.

Orthogonal Frequency Division Multiplexing (OFDM) utilizes a large number of sub-carriers to carry data. Those sub-carriers are orthogonal to each other. In 802.16m physical sub-carriers, grouped into Physical Resource Units (PRUs) are divided into Frequency Partitions (FPs) and further into Contiguous Resource Unites (CRUs) and Distributed Recourse Unit groups (DRUs). The usage scenarios of those frequency resources may be different: DRUs may be used to achieve frequency-diversity gain while the CRUs may be used to achieve frequency-selective scheduling gain. Frequency-selective scheduling is one of the most obvious usages of the uplink channel sounding.

### SUMMARY

Various aspects of the invention are set out in the claims.

In accordance with an example embodiment of the present invention, a method is disclosed that comprises receiving a resource reservation request for a sounding channel, the resource reservation request comprising a first transmission direction and a first set of logical resources; mapping the first set of logical resources to a first set of physical resources, at least in part based on the first transmission direction; and mapping the first set of physical resources to a second set of logical resources at least in part based on a second transmission direction.

In accordance with another example embodiment of the present invention, an apparatus comprises a first module configured to receive a resource reservation request for a sounding channel, the resource reservation request comprising a first transmission direction and a first set of logical resources; and a second module configured to map the first set of logical resources to a first set of physical resources, at least in part based on the first transmission direction; and to map the first set of physical resources to a second set of logical resources at least in part based on a second transmission direction.

In accordance with another example embodiment of the present invention, a computer program product comprises a computer-readable medium bearing computer program code embodied therein for use with a computer, the computer program code comprising code for receiving a resource reservation request for a sounding channel, the resource reservation request comprising a first transmission direction and a first set of logical resources; code for mapping the first set of logical resource groups to a first set of physical resources, at least in part based on the first transmission direction; and code for mapping the first set of physical resources to a second set of logical resources at least in part based on a second transmission direction.

### BRIEF DESCRIPTION OF THE DRAWINGS

For a more complete understanding of example embodiments of the present invention, the objects and potential advantages thereof, reference is now made to the following descriptions taken in connection with the accompanying drawings in which:

FIG. 1 illustrates an example wireless system;

FIG. 2 illustrates an example method for mapping sounding channel resources at a mobile station;

FIG. 3 illustrates an example sounding channel module; and

FIG. 4 illustrate an example embodiment of sounding channel resource mapping.

### DETAILED DESCRIPTION

Resource allocation for sounding channel may match to the mapping from downlink sub-carriers to logical resource units to support application such as sounding channel based preceding for time division duplex (TDD) downlink closed loop multiple-input multiple-output (MIMO) antenna. The asymmetric resource allocations between the uplink direction and the downlink direction may result in different uplink and downlink sub-carrier to resource unit mappings. This issue may be addressed by establishing sounding zone and allocating sounding channels within sounding zone. However, this approach may have more overhead, because the sounding zone may occupy a whole sub-frame, leaving part of the sub-frame unused. It is advantageous to allocate sounding channel within contiguous or distributed groups of frequency partitions (FPs). One issue to be addressed is to have an efficient method and system to match the sounding channel to downlink contiguous or distributed groups and at the same time to allocate the sound channel within time-frequency resources.

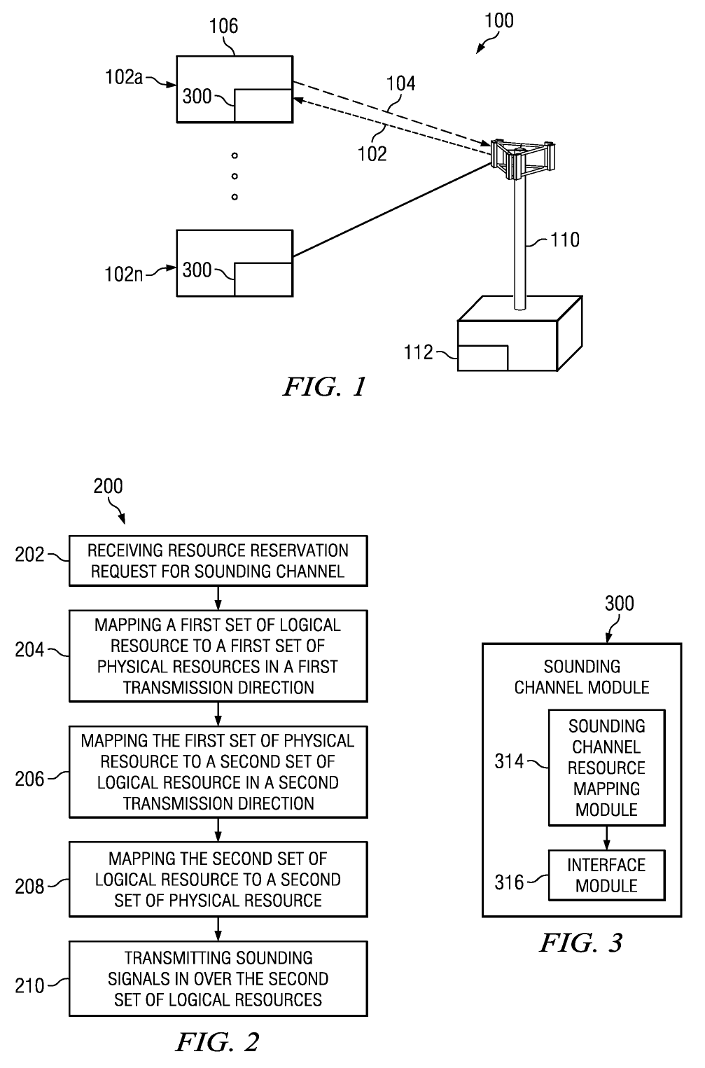

An example embodiment of the present invention and its potential advantages are best understood by referring to FIGS. 1 through 5 of the drawings, like numerals being used for like and corresponding parts of the various drawings. The various embodiments used to describe the principles of the present disclosure in this disclosure are by way of illustration only and should not be construed in any way to limit the scope of the invention. Those skilled in the art will understand that the principles of the present disclosure may be implemented in any type of suitably arranged device or system.

FIG. 1 illustrates an example wireless system 100. The example wireless system 100 may include a base station 110, and a number of mobile stations 102a through 102n. Each mobile station in turn may include a sounding channel module 300 and each mobile station 102 is coupled to the base station 110 via at least two wireless channels, a sounding channel 104 and a control channel 102. The base station 110 may include a second sounding channel module 112.

The sounding channel 104 is an uplink sounding channel that may provide channel response information to the BS 110 on an as-needed basis. The sounding channel 104 may be used for single, multiuser, multi-cell MIMO feedback, downlink channel quality feedback, and obtaining uplink channel information at the BS, among others. In time-division-duplex (TDD) system, downlink channel response may be derived from the estimate of the uplink channel at BS, assuming that uplink and downlink channels are reciprocal. This estimate can be done relying on the uplink data transmission or sounding or reference signal from MS. The later is preferable in OFDM based systems, because uplink data transmission may not occupy the same portion of a frequency band as downlink transmission. In addition, the uplink and downlink permutations can be different.

Sounding signals, transmitted by different MSs, can be time-multiplexed. They may be transmitted in the different OFDM symbols or within the same OFDM symbol. In the latter case, orthogonal signals are used. At least two methods of maintaining orthogonality are known, either by code division multiplexing codes or by allocating to each MS a set of non-overlapping subcarriers.

The downlink control channel 102 may be used to send a resource reservation request from the base station 110 to allocate resources for an uplink sounding channel. A resource reservation request may include a set of logical resources and a transmission direction that may be a downlink or an uplink direction. Sounding signals from one or several MSs may be allocated in the sounding channel. Sounding channel is time-frequency sub-carriers that are reserved for allocation of the sounding signals. Depending on the method of maintaining orthogonality between sounding signals that may be an frequency division multiple approach or code division multiplex approach, one time-frequency sub-carrier may be used by one or several MSs. The approach of allocation of the sounding channel prior to allocation of the sounding signals allows optimizing downlink signaling.

The sounding channel module 300 may be configured to map from a set of CRUs/DRUs to a set of physical resources in a downlink direction. Then the sounding channel module 300 may map the physical resources to another set of CRUs/DRUs in the uplink direction that may be recognized by the base station. More details of the sounding channel module 300 are illustrated in FIG. 3 and described hereinafter.

The base station 110 may be a WiMax advanced base station and may include the second sounding channel module 112 that may be configured to generate the uplink sounding channel resource reservation request, and perform substantially same functions as the sounding channel module 300 in the mobile station 102.

In an example embodiment of a WiMax wireless system, the sounding channel module 112 in the base station 110 generate a sounding channel resource reservation request every n milliseconds where n can be anywhere between single-digit number to a three-digit number. The base station 110 may send the request via a broadcast channel to all the mobile stations 102a through 102n. The request may request that mobile stations feedback channel quality of a set of downlink logical resources such as downlink DRUs 1, 2, 7 and 8. The channel module 300 inside the mobile station 102a may perform the following mappings. The sounding channel module 300 may first map the downlink logical resources, for example, the downlink DRUs 1, 2, 7 and 8, to a set of downlink physical resources such as a set of time-frequency sub-carriers. Then the sounding channel module 300 may map the mapped physical resources to a set of uplink logical resources such as DRUs 5, 6, 10 and 11, and then map the set of uplink logical resource to a set of uplink physical resources. Then the mobile station 102a may transmit sounding signals over the set of uplink logical resources, for example, the DRUs 5, 6, 10, and 11. The sounding channel module 112 in the base station 110 may perform the same mappings to arrive at the same uplink logical resources DRUs 5, 6, 10 and 11 and then monitor and receive the sounding signals over the set of uplink logical resources DRUs 5, 6, 10 and 11. In this way, the base station 110 can get the channel quality of the set of downlink logical resources DRUs 1, 2, 7 and 8.

FIG. 2 illustrates an example method 200 for allocation resource for uplink sounding channel. The method 200 may include receiving a resource reservation request for a sounding channel at block 202, mapping a first set of logical resource to a first set of physical resources in a first transmission direction at block 204, and mapping the first set of physical resource to a second set of logical resource in a second transmission direction at block 206. The method 200 may also include mapping the second set of logical resources to a second set of physical resources at block 208 and transmitting the sounding signal over the second set of logical resources at block 210. Other embodiments of the method 200 with different sequences of steps could be used without departing from the scope of this disclosure. In an example embodiment, the method 200 is performed by the sounding channel module 300 in the mobile station 102 in FIG. 3 and FIG. 1. In an example embodiment, the method 200 is performed by the sounding channel module 300 of the mobile station 102. In another example embodiment, the method 200 is performed by the second sounding channel module 112 of the base station 110.

Receiving resource reservation at block 202 may include receiving a channel sounding command from a coupled base station over a broad cast channel, a dedicated management channel or a control channel. The request may include a transmission direction such as a downlink direction or an uplink direction and a first set of logical resources such as a set contiguous resource units (CRUs) or distributed resource unit (DRUs) or a mix of the two.

Mapping the first set of logical resources to a first set of physical resource at block 204 may include mapping the DRUs or CRUs to a first set of subcarrier in time-frequency domain, according to a set of downlink mapping algorithm or rules. One example downlink mapping rules is the IEEE 802.16m downlink sub-channelization rules. An example embodiment of the downlink resource mapping at block 204 may be performed as follows. The downlink resource mapping may include reordering the frequency band into a set of PRUs based on an outer permutation. The downlink resource mapping then includes dividing the reordered PRUs into one or multiple frequency partitions and then dividing the PRUs in each frequency partition into CRUs and DRUs. Then downlink resource mapping may further include mapping contiguous logical resource unit to the CRUs and applying subcarrier permutation to the DRUs to get a set of distributed logical resource units, which are the basic resource units used in resource allocation by the base station 110.

Mapping the first set of physical resource to a second set of logical resource at block 206 in the second transmission direction may include mapping the first set of physical resources such as time-frequency sub-carriers in the downlink direction to a second set of logical resource in the uplink direction according to a set of uplink mapping rules. One example uplink mapping rules may be the IEEE 802.16m uplink sub-channelization rules. An example embodiment of the uplink resource mapping at block 206 may include reordering the frequency band into a set of PRUs based on a second outer permutation, dividing the set of PRUs into one or multiple frequency partitions, and dividing the PRUs in each frequency partition into a set of CRUs and DRUs. The uplink resource mapping at block 206 may also include mapping the CRUs directly to a set of contiguous logical resource unit, and applying a permutation to the DRUs to get a set of distributed logical resource units, which are the basic resource units used in resource allocation by the base station 110.

Mapping the second set of logical resource to a second set of physical at block 208 may include mapping the second set of DRUs/CRUs to a second set of time-frequency subcarrier in the uplink direction using a set of downlink mapping rules. One example downlink mapping rules is the IEEE 802.16m downlink sub-channelization rules. An example embodiment of the second set of physical to logical resource mapping at block 208 may be performed as follows. The second set of physical to logical resource mapping may include reordering the frequency band into a set of PRUs based on an outer permutation. The second set of physical to logical resource mapping then includes dividing the reordered PRUs into one or multiple frequency partitions and then dividing the PRUs in each frequency partition into CRUs and DRUs. Then second set of physical to logical resource mapping may further include mapping contiguous logical resource unit to the CRUs and applying subcarrier permutation to the DRUs to get a set of distributed logical resource units, which are the basic resource units used in resource allocation by the base station 110.

Transmitting a set of sounding signals over the second set of logical resources at block 210 may include allocating sounding signals into the sounding channel and transmitting sounding signals such as digital modulation signals for channel quality data over the second set of logical resources.

FIG. 3 illustrates an example sounding channel module 300. The sounding channel module 300 may include a channel sounding resource mapping module 314 and an interface module 316. The channel sounding resource mapping module 314 may map the first set of logical resource to the first set of physical resource in the downlink direction and map the first set of physical resource to the second set of logical resources in the uplink direction. The channel sounding resource mapping module 314 may also map the second set of logical resources to the second set of physical resources in the uplink direction. The interface module 316 may receive a channel sounding resource reservation request from the coupled base station 110 and may also transmit channel sounding signals over the mapped second set of logical resources.

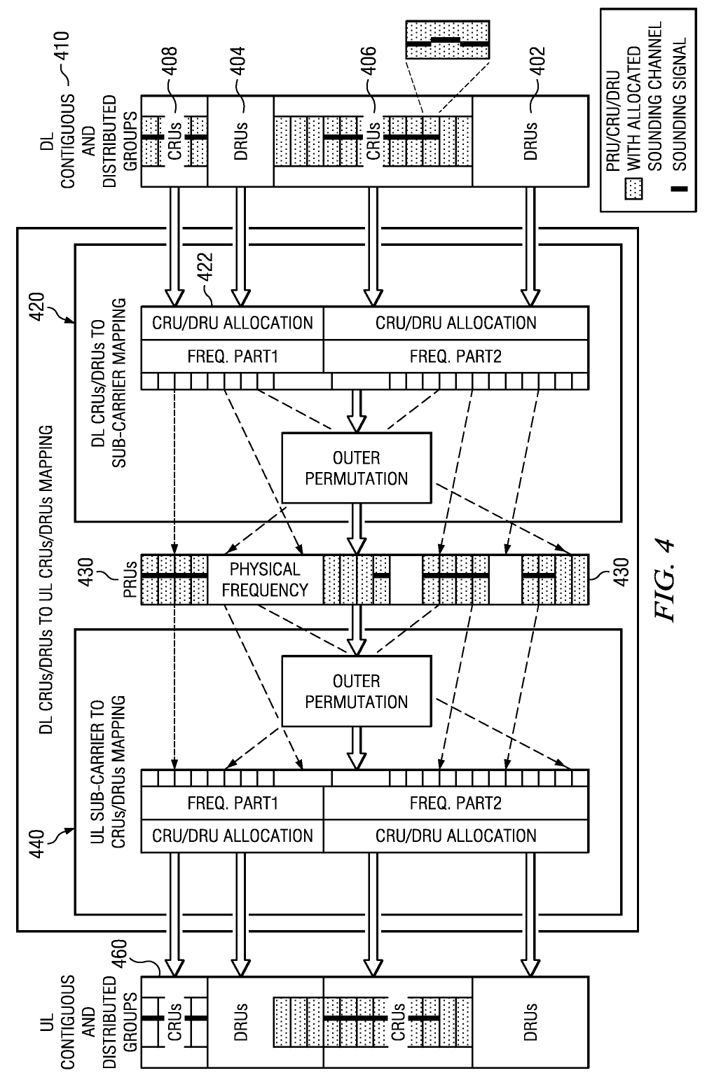

FIG. 4 illustrate an example embodiment of sound channel resource mappings. The section 410 illustrates two CRUs 406 and 408 and two DRUs 402 and 404. The two sets of CRUs and DRUs are mapped into a first set of sub-carriers in the two frequency partitions as shown in section 420. In the section 420, the frequency band is reordered into a set of PRUs based on an outer permutation. The reordered PRUs are then divided into two frequency partitions, and the PRUs in each frequency partition are divided into CRUs and DRUs as shown in 422. The contiguous logical resource units are directly mapped to the CRUs. The section 430 illustrates that a set of DRUs that may be obtained from the first set of sub-carriers in the frequency domain after a sub-carrier permutation is applied to the PRUs.

The section 440 shows a mapping from the uplink sub-carriers to the second set logical resource CRU/DRUs. The uplink outer permutation reorders the PRUs of the frequency band. The reordered PRUs are divided into one or multiple uplink frequency partitions. The PRUs in each frequency partition are divided into one or more sets of CRUs and DRUs. The CRUs are directly mapped to a set of contiguous logical resource unit. A permutation is applied to the DRUs to get a set of distributed logical resource units, where logical resource units are the basic resource units used in resource allocation by the base station. The section 460 shows a set of resulting CRUs and DRUs from the mapping shown in the section 440.

Without in any way limiting the scope, interpretation, or application of the claims appearing below, it is possible that a technical advantage of one or more of the example embodiments disclosed herein may make the allocation of the uplink data and the sounding channel consistent with the downlink resource mapping in the same uplink physical resource units. This may do away with special sounding zone and thus reduce the overhead in sounding channel allocation. Another possible technical advantage of one or more of the example embodiments disclosed herein may be reduction of downlink signaling for allocation of the sounding channel matched to the downlink resource mapping. Fragmentation of the sounding channel into sub-channels is typically less than that of the same channel mapped to physical resource units, and therefore overhead of sending control information is less than otherwise at a base station.

Embodiments of the present invention may be implemented in software, hardware, application logic or a combination of software, hardware and application logic. The software, application logic and/or hardware may reside on a mobile station, a base station or other mobile computing device. If desired, part of the software, application logic and/or hardware may reside on a mobile station, part of the software, application logic and/or hardware may reside on a base station, and part of the software, application logic and/or hardware may reside on a second mobile station. The application logic, software or an instruction set is preferably maintained on any one of various conventional computer-readable media. In the context of this document, a “computer-readable medium” can be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes exemplifying embodiments of the invention, these descriptions should not be viewed in a limiting sense. Rather, there are several variations and modifications which may be made without departing from the scope of the present invention as defined in the appended claims.

What is claimed is:

1. A method, comprising:
receiving a resource reservation request for a sounding channel, the resource reservation request comprising a first transmission direction and a first set of logical resources;
mapping the first set of logical resources to a first set of physical resources, at least in part based on the first transmission direction; and
mapping the first set of physical resources to a second set of logical resources at least in part based on a second transmission direction.

2. The method of claim 1, further comprising mapping the second set of logical resources to a second set of physical resources, at least in part based on the second transmission direction.

3. The method of claim 2, further comprising sending channel sounding signals over the second set of physical resources to a coupled IEEE 802.16 advanced base station.

4. The method of claim 2, wherein mapping the first set of physical resources to the second set of logical resources further comprises mapping the first set of physical resources to the second set of logical resources based on a first mapping rule and mapping the second set of physical resources comprises mapping the second set of physical resources to the second set of logical resources based on a second mapping rule.

5. The method of claim 4, wherein the first mapping rule is an IEEE 802.16m uplink sub-channelization rule and the second mapping rule is an IEEE 802.16m uplink sub-channelization rule.

6. The method of claim 1, wherein mapping the first set of logical resources to the first set of physical resources further comprises reordering a frequency band into a set of physical resource units (PRUs) based on an outer permutation, dividing the reordered PRUs into one or more frequency partitions, and dividing the PRUs in each frequency partition into one or more contiguous resource units (CRUs) and distributed resource units (DRUs).

7. The method of claim 6, mapping the first set of logical resources to the first set of physical resources further comprises mapping one or more contiguous logical resource units to the CRUs and applying a subcarrier permutation to the DRUs to obtain a set of distributed logical resource units.

8. The method of claim 1, wherein the first transmission direction is a downlink direction and the second transmission direction is an uplink direction.

9. The method of claim 1, wherein mapping the first set of physical resources to the second set of logical resources further comprises reordering a frequency band into a set of PRUs based on a second outer permutation, dividing the set of PRUs into one or more frequency partitions, dividing the PRUs in each frequency partition into a set of CRUs and DRUs, mapping the CRUs to a set of contiguous logical resource units, and applying a subcarrier permutation to the DRUs to obtain a set of distributed logical resource units.

10. An apparatus, comprising:
a first module configured
to receive a resource reservation request for a sounding channel, the resource reservation request comprising a first transmission direction and a first set of logical resources; and
a second module configured
to map the first set of logical resources to a first set of physical resources, at least in part based on the first transmission direction; and
to map the first set of physical resources to a second set of logical resources at least in part based on a second transmission direction.

11. The apparatus of claim 10, wherein the first transmission direction is a downlink direction and the second transmission direction is an uplink direction.

12. The apparatus of claim 11, wherein the second module is further configured to map the second set of logical resources to a second set of physical resources, at least in part based on the second transmission direction.

13. The apparatus of claim 12, where the first module is further configured to send channel sounding signals over the second set of physical resources to a coupled IEEE 802.16 advanced base station.

14. The apparatus of claim 12, wherein the first set of physical resource comprises a first set of time-frequency sub-carriers and the second set of physical resource comprises a second set of time-frequency sub-carriers.

15. The apparatus of claim 14, wherein the first set of logical resources comprises at least one of a first set of contiguous resource units (CRUs) and a first set of distributed resource units (DRUs) and the second set of logical resource comprise at least one of a second set of CRUs and a second set of DRUs.

16. The apparatus of claim 15, wherein the second module is configured to map the at least one of the first set of CRUs and the first set of DRUs to the first set of time-frequency sub-carriers in the downlink direction.

17. The apparatus of claim 15, wherein the second module is configured to map the at least one of the second set of CRUs and the second set of DRUs to the second set of time-frequency sub-carriers in the uplink direction wherein there is not a collision with any pilot signal and control signal over the second set of time-frequency sub-carriers.

18. The apparatus of claim 10, wherein the apparatus is one of an IEEE 802.16 compliant mobile station, and an advanced mobile station, a base station, and an advanced base station.

19. A computer program product comprising a computer-readable medium bearing computer program code embodied therein for use with a computer, the computer program code comprising:
code for receiving a resource reservation request for a sounding channel, the resource reservation request comprising a first transmission direction and a first set of logical resources;
code for mapping the first set of logical resource groups to a first set of physical resources, at least in part based on the first transmission direction; and
code for mapping the first set of physical resources to a second set of logical resources at least in part based on a second transmission direction.

20. The computer program product of claim 19, wherein the computer program code further comprises:
code for mapping the second set of logical resources to a second set of physical resources, at least in part based on the first transmission direction.
